(19) United States
(12) Patent Application Publication
(10) Pub. No.: US 2006/0038918 A1
(43) Pub. Date: Feb. 23, 2006

(54) Unit for and method of image conversion

(75) Inventor: Gerard De Haan, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronice N. V., Eindhoven (NL)

(21) Appl. No.: 10/528,488

(22) PCT Filed: Aug. 8, 2003
(86) PCT No.: PCT/IB03/03563

§ 371 Date: Mar. 18, 2005

(30) Foreign Application Priority Data
Sep. 23, 2002 (EP) 02078991.3

(51) Int. Cl. G06K 9/32

(52) U.S. Cl. 348/441; 382/299

(57) ABSTRACT

An image conversion unit (200) for converting a first input image with a first resolution into an output image with a second resolution, comprises a coefficient-calculating means (106) for calculating a first filter coefficient on basis of pixel values of the first input image and of pixel values of a second input image. The coefficient-calculating means (106) is arranged to control an adaptive filtering means (104) for calculating a pixel value of the output image on basis of an input pixel value of the first image and the first filter coefficient

The invention relates to an image conversion unit for converting a first image sequence, comprising a first image with a first resolution and a second image with the first resolution into a second image sequence comprising a third image with a second resolution, the image conversion unit comprising:

a coefficient-calculating means for calculating a first filter coefficient on basis of pixel values of the first image;

an adaptive filtering means for calculating a third pixel value of the third image on basis of a first one of the pixel values of the first image and the first filter coefficient.

The invention further relates to a method of converting a first image sequence, comprising a first image with a first resolution and a second image with the first resolution into a second image sequence comprising a third image with a second resolution, the method comprising:

calculating a first filter coefficient on basis of pixel values of the first image; and

calculating a third pixel value of the third image on basis of a first one of the pixel values of the first image and the first filter coefficient.

The invention further relates to an image processing apparatus comprising:

receiving means for receiving a signal corresponding to a first image sequence; and

the above mentioned image conversion unit for converting the first image sequence into a second image sequence.

The advent of HDTV emphasizes the need for spatial up-conversion techniques that enable standard definition (SD) video material to be viewed on high definition (HD) television (TV) displays. Conventional techniques are linear interpolation methods such as bi-linear interpolation and methods using poly-phase low-pass interpolation filters. The former is not popular in television applications because of its low quality, but the latter is available in commercially available ICs. With the linear methods, the number of pixels in the frame is increased, but the high frequency part of the spectrum is not extended, i.e. the perceived sharpness of the image is not increased. In other words, the capability of the display is not fully exploited.

Additional to the conventional linear techniques, a number of non-linear algorithms have been proposed to achieve this up-conversion. Sometimes these techniques are referred to as content-based or edge dependent spatial up-conversion. Some of the techniques are already available on the consumer electronics market.

An embodiment of the image conversion unit of the kind described in the opening paragraph is known from the article “New Edge-Directed Interpolation”, by Xin Li et al., in IEEE Transactions on Image Processing, Vol. 10, No 10, October 2001, pp. 1521-1527. In this image conversion unit, the filter coefficients of an interpolation up-conversion filter are adapted to the local image content. The interpolation up-conversion filter aperture uses a fourth order interpolation algorithm as specified in Equation 1:

$${F}_{HD} ( 2 ( i + 1 ) , 2 ( j + 1 ) ) = {\sum }_{k = 0}^{1} {\sum }_{l = 0}^{1} {w}_{2 k + l} {F}_{SD} ( 2 i + 2 k , 2 j + 2 l ) \qquad ( 1 )$$

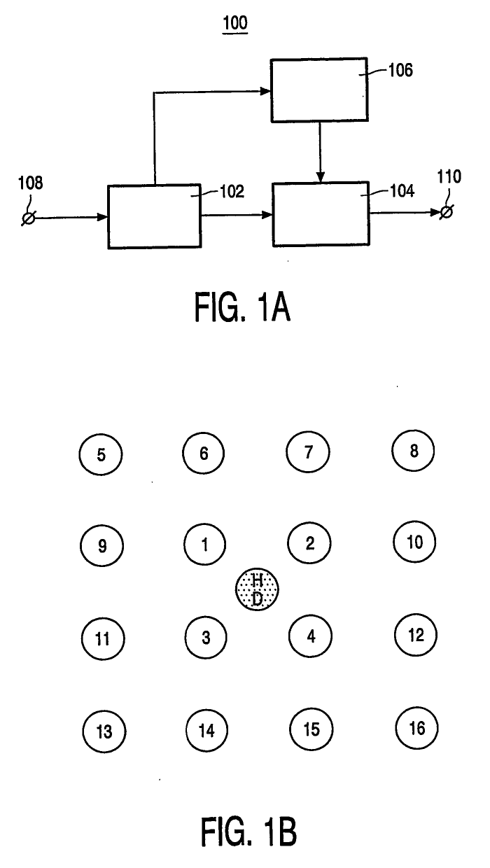

with F_{HD}(i, j) the luminance values of the HD output pixels, F_{SD}(i, j) the luminance values of the input pixels and wᵢ the filter coefficients. The filter coefficients are obtained from a larger aperture using a Least Mean Squares (LMS) optimization procedure. In the cited article is explained how the filter coefficients are calculated. The method according to the prior art is also explained in connection with FIG. 1A and FIG. 1B. The method aims at interpolating along edges rather than across them to prevent blurring. The authors make the sensible assumption that edge orientation does not change with scaling. Therefore, the coefficients can be approximated from the SD input image within a local window by using the LMS method.

Although the “New Edge-Directed Interpolation” method according to the cited prior art works relatively well in many image parts, there is a problem with selecting the appropriate window for the LMS method. For windows of size it by in, there are (n−2)(m−2) equations. Experimentally, the inventor found that a window of 4 by 4, which results in 4 equations did not lead to a robust up scaling. Better results have been obtained using windows of 8 by 8, i.e. with 36 equations. Although the up-conversion was more robust, there was also more blurring. It is assumed that this is due to the fact that the image statistics are not constant over this larger area, which causes the filter to converge towards a plain averaging filter. To conclude: there is a conflict that complicates the choice of the window size. On the one hand, because of the robustness the window size has to be large. On the other hand, for constant image statistics the window size has be as small as possible. Finally, the LMS optimization requires at least the same number of equations as there are unknown coefficients, which gives a lower bound to the window size.

It is an object of the invention to provide an image conversion unit of the kind described in the opening paragraph which is relatively robust while the amount of image blur is relatively low.

This object of the invention is achieved in that the coefficient-calculating means is arranged to calculate the first filter coefficient on basis of further pixel values of the second image. In other words the aperture of the coefficient-calculating means is enlarged in the temporal domain rather than in the spatial domain. The assumption then is that in corresponding -smaller- image parts of different images, the statistics are more similar than in different locations of a -larger- part in the same image. This is particularly to be expected in the case that the corresponding image parts are taken along the motion trajectory. So, additional to the assumption that edge orientation is independent of scale, it is now assumed that edge orientation is constant over time when corrected for motion. Pixel values are luminance values or color values.

Notice that the further pixel values are not applied in the direct path of processing the input pixels of the first image into output pixels, i.e. the pixels of the third image, but in the control path to determine the filter coefficients. Combining input pixel values of multiple input fields into a single output pixel value of a single output image, i.e. frame, is for instance known as de-interlacing. Interlacing is the common video broadcast procedure for transmitting the odd and even numbered image lines alternately. De-interlacing attempts to restore the full vertical resolution, i.e. make odd and even lines available simultaneously for each image. The purpose of de-interlacing is the reduction of alias in successive fields. However a purpose of the image conversion unit according to the present invention is to increase the resolution of input images on basis of respective input images. This is done by means of a spatial filter which is adapted to edges in order to limit the amount of blur which would arise without the adaptation to the edges. The spatial filter in controlled by means of filter coefficients which are determined on basis of multiple input images.

An embodiment of the image conversion unit according to the invention is arranged to acquire the pixel values of the first image from a first part of the first image and the further pixel values of the second image from a second part of the second image, with the first part and the second part spatially corresponding. An advantage of this embodiment is that it is relatively simple. Acquisition of the appropriate pixels from the second image is straight forward without additional calculations. Temporarily storage of a number of pixel values of the second image is required.

An embodiment of the image conversion unit according to the invention is arranged to acquire the pixel values of the first image from a first part of the first image and the further pixel values of the second image from a second part of the second image, with the first part and the second part at a motion trajectory. Motion vectors have to be provided by means of a motion estimator. These motion vectors describe the relation between the first part and the second part. An advantage of this embodiment is that the images of the second sequence, i.e. the output images, are relatively sharp.

In an embodiment of the image conversion unit according to the invention the coefficient-calculating means is arranged to calculate the first filter coefficient by means of an optimization algorithm. Preferably the optimization algorithm is a Least Mean Square algorithm. An LMS algorithm is relatively simple and robust.

It is a further object of the invention to provide a method of the kind described in the opening paragraph which is relatively robust while the amount of image blur is relatively low.

This object of the invention is achieved in that the first filter coefficient is calculated on basis of further pixel values of the second image.

It is a further object of the invention to provide an image processing apparatus of the kind described in the opening of which the image conversion unit is relatively robust while the amount of image blur is relatively low.

This object of the invention is achieved in that the coefficient-calculating means of the image processing apparatus is arranged to calculate the first filter coefficient on basis of further pixel values of the second image. The image processing apparatus optionally comprises a display device for displaying the second image. The image processing apparatus might e.g. be a TV, a set top box, a VCR (Video Cassette Recorder) player or a DVD (Digital Versatile Disk) player. Modifications of image conversion unit and variations thereof may correspond to modifications and variations thereof of the method and of the image processing apparatus described.

These and other aspects of the image conversion unit, of the method and of the image processing apparatus according to the invention will become apparent from and will be elucidated with respect to the implementations and embodiments described hereinafter and with reference to the accompanying drawings, wherein:

FIG. 1A schematically shows an embodiment of the image conversion unit according to the prior art;

FIG. 1B schematically shows a number of pixels to explain the method according to the prior art;

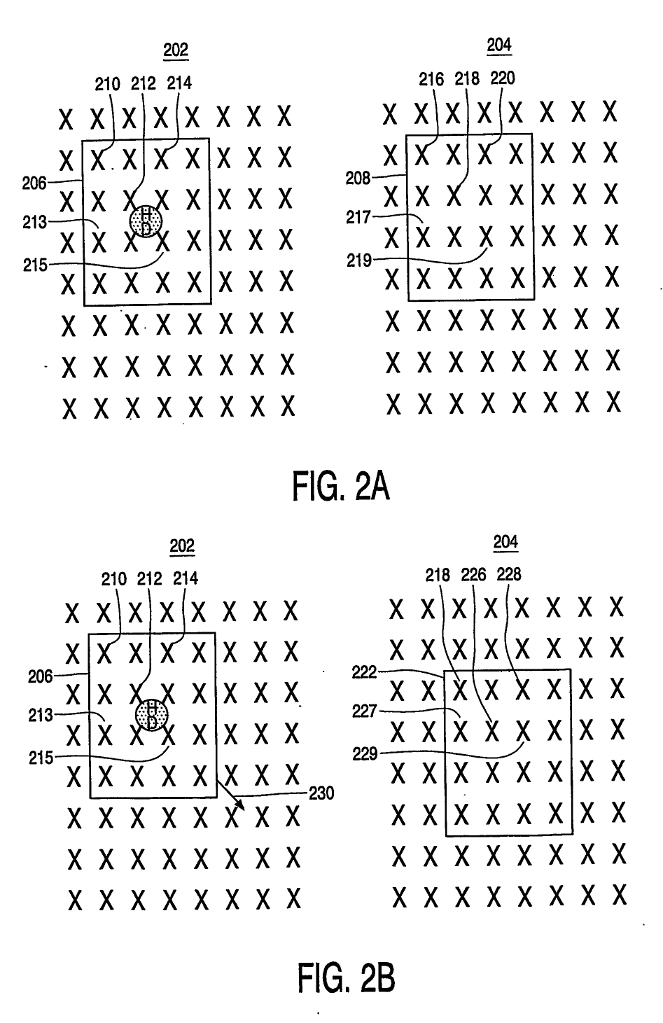

FIG. 2A schematically shows two images to explain an embodiment of the method according to the invention;

FIG. 2B schematically shows two images to explain an alternative embodiment of the method according to the invention;

FIG. 2C schematically shows an embodiment of the image conversion unit according to the invention;

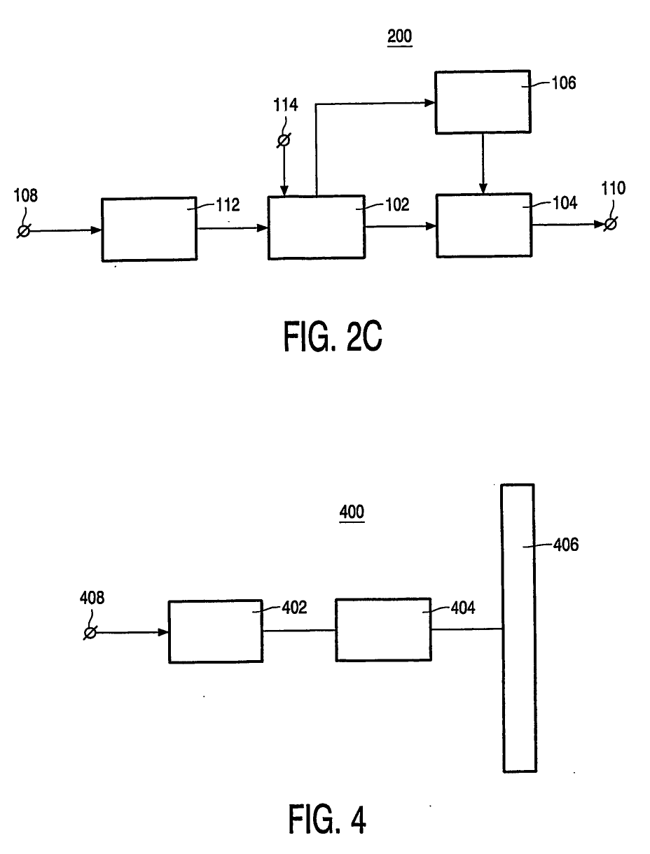

FIG. 3A schematically shows an SD input image;

FIG. 3B schematically shows the SD input image of FIG. 3A on which pixels are added in order to increase the resolution;

FIG. 3C schematically shows the image of FIG. 3B after being rotated over 45 degrees;

FIG. 3D schematically shows an HD output image derived from the SD input image of FIG. 3A; and

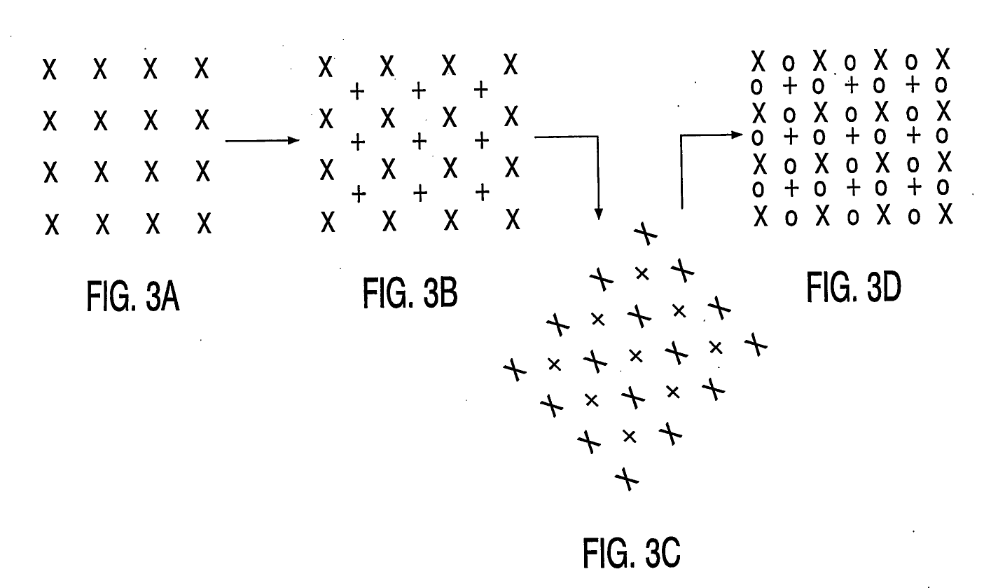

FIG. 4 schematically shows an embodiment of the image processing apparatus according to the invention.

Same reference numerals are used to denote similar parts throughout the figures.

FIG. 1A schematically shows an embodiment of the image conversion unit 100 according to the prior art. The image conversion unit 100 is provided with standard definition (SD) images at the input connector 108 and provides high definition (HD) images at the output connector 110. The image conversion unit 100 comprises:

A pixel acquisition unit 102 which is arranged to acquire a first set of pixel values of pixels 1-4 (See FIG. 1B) in a first neighborhood of a particular location within a first one of the SD input images which corresponds with the location of an HD output pixel and is arranged to acquire a second set of pixel values of pixels 1-16 in a second neighborhood of the particular location within the first one of the SD input images;

A filter coefficient-calculating unit 106, which is arranged to calculate filter coefficients on basis of the first set of pixel values and the second set of pixel values. In other words, the filter coefficients are approximated from the SD input image within a local window. This is done by using a Least Mean Squares (LMS) method which is explained in connection with FIG. 1B.

An adaptive filtering unit 104 for calculating the pixel value of the HD output pixel on basis of the first set of pixel values and the filter coefficients as specified in Equation 1. Hence the filter coefficient-calculating unit 106 is arranged to control the adaptive filtering unit 104.

FIG. 1B schematically shows a number of pixels 1-16 of an SD input image and one H) pixel of an HD output image, to explain the method according to the prior art. The HD output pixel is interpolated as a weighted average of 4 pixel values of pixels 1-4. That means that the luminance value of the HD output pixel F_{HD} results as a weighted sum of the luminance values of its 4 SD neighboring pixels:
F_{HD}=w₁F_{SD}(1)+w₂F_{SD}(2)+w₃F_{SD}(3)+w₄F_{SD}(4), (2)
where F_{SD}(1) to F_{SD}(4) are the pixel values of the 4 SD input pixels 1-4 and w₁ to w₄ are the filter coefficients to be calculated by means of the LMS method. The authors of the cited article in which the prior art method is described, make the sensible assumption that edge orientation does not change with scaling. The consequence of this assumption is that the optimal filter coefficients are the same as those to interpolate, on the standard resolution grid:

Pixel 1 from 5, 7, 11, and 4 (that means that pixel 1 can be derived from its 4 neighbors)

Pixel 2 from 6, 8, 3, and 12

Pixel 3 from 9, 2, 13, and 15

Pixel 4 from 1, 10, 14, and 16

This gives a set of 4 linear equations from which with the LSM-optimization the optimal 4 filter coefficients to interpolate the HD output pixel are found.

Denoting M as the pixel set, on the SD -grid, used to calculate the 4 weights, the Means Square Error (MSE) over set M in the optimization can be written as the sum of squared differences between original SD-pixels F_{SD} and interpolated SD-pixels F_{SI}:

$$MSE = {\sum }_{{F}_{SD} ( i , j ) ∈ M}^{} {( {F}_{SD} ( 2 i + 2 , 2 j + 2 ) - {F}_{SI} ( 2 i + 2 , 2 j + 2 ) )}^{2} \qquad ( 3 )$$

Which in matrix formulation becomes:

$$MSE = {‖ \vec{y} - \vec{w} C ‖}^{2} \qquad ( 4 )$$

Here \vec{y} contains the SD-pixels in M (pixel F_{SD}(1,1) to F_{SD}(1,4), F_{SD}(2,1) to F_{SD}(2,4), F_{SD}(3,1) to F_{SD}(3,4), F_{SD}(4,1) to F_{SD}(4,4) and C is a 4×M² matrix whose k^{th} row is composed of the weighted sum of the four diagonal SD-neighbors of each SD-pixels in \vec{y}.

The weighted sum of each row describes a pixel F_{SI}, as used in Equation 3. To find the minimum MSE, i.e. LMS, the derivation of MSE over \vec{w} is calculated:

$$\begin{matrix}\frac{\partial ( MSE )}{\partial w} = 0 & ( 5 ) \\ - 2 \vec{y} C + 2 \vec{w} {C}^{2} = 0 & ( 6 ) \\ \vec{w} = {( {C}^{T} C )}^{- 1} ( {C}^{T} \vec{y} ) & ( 7 )\end{matrix}$$

By solving Equation 7 the filter coefficients are found and by using Equation 2 the pixel values of the HD output pixels can be calculated.

In this example a window of 4 by 4 pixels is used for the calculation of the filter coefficients. An LMS optimization on a larger window, e.g. 8 by 8 instead of 4 by 4 gives better results.

FIG. 2A schematically shows two SD input images 202, 204 to explain an embodiment of the method according to the invention. Each of the two SD input images 202, 204 comprises a number of pixels, e.g. 210-220 which are indicated with X-signs. Suppose that an HD output pixel has to be calculated. The location corresponding to this HD output pixel is indicated in a first one of the input images 202. For the calculation of a first filter coefficient, e.g. with which SD input pixel 212 has to be multiplied, a set of equations has to be solved as explained in connection with FIG. 1B. The known components of these equations correspond with pixel values e.g. 210-215 taken from a first part 206 of the first one of the input images 202, but also with pixel values e.g. 216-220 taken from a second part 208 of a second one of the input images 204. Preferably the pixel values which are used to determine he first filter coefficient of a particular pixel 212 are acquired from the local neighborhood. That means that the pixels which are connected to the particular pixel 212 are applied, e.g. the upper, the lower, the right, the left and the diagonal pixels. The pixel values of the second image are also acquired from a local neighborhood which corresponds to the local neighborhood in the first image. The first part 206 of the first one of the input images 202 and the second part 208 of the second one of the input images 204 are spatially corresponding. That means that all respective pixels of the first part 206 have the same coordinates as the corresponding pixels of the second part 208. That is not the case with the images parts 206 and 222 as depicted in FIG. 2B.

FIG. 2B schematically shows two images 202, 204 to explain an alternative embodiment of the method according to the invention. The first part 206 of the first one of the input images 202 and the third part 222 of the second one of the input images 204 are located at a motion trajectory. The relation between the first part 206 and the third part 222 is determined by the motion vector 230 which has been calculated by means of a motion estimator. This motion estimator might be the motion estimator as described in the article “True-Motion Estimation with 3-D Recursive Search Block Matching” by G. de Haan et. al. in IEEE Transactions on circuits and systems for video technology, vol. 3, no. 5, October 1993, pages 368-379. In this case the respective pixels of the two image parts correspond to substantially equal picture content although there was movement of objects in the scene being imaged.

FIG. 2C schematically shows an embodiment of the image conversion unit 200 according to the invention. The image conversion unit 200 is provided with standard definition (SD) images at the input connector 108 and provides high definition (HD) images at the output connector 110. The SD input images have pixel matrices as specified in CCIR-601, e.g. 625*720 pixels or 525*720 pixels. The HD output images have pixel matrices with e.g. twice or one-and-a-halve times the number of pixels in horizontal and vertical direction. The image conversion unit 200 comprises:

A memory device for storage of a number of pixels of a number of SD input images.

A pixel acquisition unit 102 which is arranged to acquire:

a first set of pixel values of pixels from a first one of the SD input images in a first neighborhood of a particular location within the first SD input image, which corresponds with the location of the output pixel HD.

a second set of pixel values of pixels from the first SD input image in a second neighborhood of the particular location;

a third set of pixel values of pixels from a second one of the SD input images in a third neighborhood of the particular location;

an optional fourth set of pixel values of pixels from a third one of the SD input images in a fourth neighborhood of the particular location.

A filter coefficient-calculating unit 106 which is arranged to calculate filter coefficients on basis of the first, second, third and optionally fourth set of pixel values. In other words, the filter coefficients are approximated from the SD input images within a local window located in the first SD input image and the window extending to the second SD input image and optionally to the third SD input image. Preferably the second SD input image and the third SD input image are respectively preceding and succeeding the first SD input image in the sequence of SD input images. The approximation of the filter coefficients is done by using a Least Mean Squares (LMS) method which is explained in connection with FIG. 1B, FIG. 2A and FIG. 2B; and

An adaptive filtering unit 104 for calculating a pixel value of an HD output image on basis of the second set of pixel values. The HD output pixel is calculated as the weighted sum of the pixel values of the first set of pixel values.

The image conversion unit 200 optionally comprises an input connector 114 for providing motion vectors to be applied by the pixel acquisition unit 102 for the acquisition of pixel values in the succeeding SD input images of the SD input image sequence, which are on respective motion trajectories, as explained in connection with FIG. 2B.

The number of pixels acquired in the neighborhood, i.e. the window size, might be even or odd, e.g. 4*4 or 5*5 respectively. Besides that the shape of the window does not have to be rectangular. Also the number of pixels acquired from the first image and the number of pixels acquired from the second image does not have to be mutually equal.

The pixel acquisition unit 102, the filter coefficient-calculating unit 106 and the adaptive filtering unit 104 may be implemented using one processor. Normally, these functions are performed under control of a software program product. During execution, normally the software program product is loaded into a memory, like a RAM, and executed from there. The program may be loaded from a background memory, like a ROM, hard disk, or magnetically and/or optical storage, or may be loaded via a network like Internet. Optionally an application specific integrated circuit provides the disclosed functionality.

To convert an SD input image into an HD output image a number of processing steps are needed. By means of FIGS. 3A-3D these processing steps are explained. FIG. 3A schematically shows an SD input image; FIG. 3D schematically shows an HD output image derived from the SD input image of FIG. 3A and FIGS. 3B and 3C schematically show intermediate results.

FIG. 3A schematically shows an SD input image. Each X-sign correspond with a respective pixel.

FIG. 3B schematically shows the SD input image of FIG. 3A on which pixels are added in order to increase the resolution. The added pixels are indicated with +-signs. These added pixels are calculated by means of interpolation of the respective diagonal neighbors. The filter coefficients for the interpolation are determined as described in connection with FIG. 2B.

FIG. 3C schematically shows the image of FIG. 3B after being rotated over 45 degrees. The same image conversion unit 200 as being applied to calculate the image as depicted in FIG. 3B on basis of FIG. 3A can be used to calculate the image as shown in FIG. 3D on basis of the image as depicted in FIG. 3B. That means that new pixel values are calculated by means of interpolation of the respective diagonal neighbors. Notice that a first portion of these diagonal neighbors (indicated with X-signs) correspond to the original pixel values of the SD input image and that a second portion of these diagonal neighbors (indicated with +-signs) correspond to pixel values which have been derived from the original pixel values of the SD input image by means of interpolation.

FIG. 3D schematically shows the final HD output image. The pixels that have been added in the last conversion step are indicated with o-signs.

FIG. 4 schematically shows an embodiment of the image processing apparatus 400 according to the invention, comprising:

Receiving means 402 for receiving a signal representing SD images. The signal may be a broadcast signal received via an antenna or cable but may also be a signal from a storage device like a VCR (Video Cassette Recorder) or Digital Versatile Disk (DVD). The signal is provided at the input connector 408;

The image conversion unit 404 as described in connection with FIG. 2B; and

A display device 406 for displaying the HD output images of the image conversion unit 200. This display device 406 is optional.

The image processing apparatus 400 might e.g. be a TV. Alternatively the image processing apparatus 400 does not comprise the optional display device but provides HD images to an apparatus that does comprise a display device 406. Then the image processing apparatus 400 might be e.g. a set top box, a satellite-tuner, a VCR player or a DVD player. But it might also be a system being applied by a film-studio or broadcaster.

It should be noted that the above-mentioned embodiments illustrate rather than limit the invention and that those skilled in the art will be able to design alternative embodiments without departing from the scope of the appended claims. In the claims, any reference signs placed between parentheses shall not be constructed as limiting the claim. The word ‘comprising’ does not exclude the presence of elements or steps not listed in a claim. The word “a” or “an” preceding an element does not exclude the presence of a plurality of such elements. The invention can be implemented by means of hardware comprising several distinct elements and by means of a suitable programmed computer. In the unit claims enumerating several means, several of these means can be embodied by one and the same item of hardware.

1. An image conversion unit (200) for converting a first image sequence, comprising a first image with a first resolution and a second image with the first resolution into a second image sequence comprising a third image with a second resolution, the image conversion unit (200) comprising:
a coefficient-calculating means (106) for calculating a first filter coefficient on basis of pixel values of the first image;
an adaptive filtering means (104) for calculating a third pixel value of the third image on basis of a first one of the pixel values of the first image and the first filter coefficient, characterized in that the coefficient-calculating means (106) is arranged to calculate the first filter coefficient on basis of further pixel values of the second image.

2. An image conversion unit (200) as claimed in claim 1, characterized in that the image conversion unit (200) is arranged to acquire the pixel values of the first image from a first part of the first image and the further pixel values of the second image from a second part of the second image, with the first part and the second part spatially corresponding.

3. An image conversion unit (200) as claimed in claim 1, characterized in that the image conversion unit (200) is arranged to acquire the pixel values of the first image from a first part of the first image and the further pixel values of the second image from a second part of the second image, with the first part and the second part at a motion trajectory.

4. An image conversion unit (200) as claimed in claim 1, characterized in that the coefficient-calculating means (106) is arranged to calculate the first filter coefficient by means of an optimization algorithm.

5. A method of converting a first image sequence, comprising a first image with a first resolution and a second image with the first resolution into a second image sequence comprising a third image with a second resolution, the method comprising:
calculating a first filter coefficient on basis of pixel values of the first image; and
calculating a third pixel value of the third image on basis of a first one of the pixel values of the first image and the first filter coefficient, characterized in that the first filter coefficient is calculated on basis of further pixel values of the second image.

6. An image processing apparatus (400) comprising:
receiving means (402) for receiving a signal corresponding to a first image sequence; and
the image conversion unit (404) for converting the first image sequence into a second image sequence, as claimed in claim 1.

7. An image processing apparatus (400) as claimed in claim 7, characterized in further comprising a display device (406) for displaying the second image sequence.

8. An image processing apparatus (400) as claimed in claim 8, characterized in that it is a TV.
